(19) United States
(12) Patent Application Publication
(10) Pub. No.: US 2005/0241710 A1
(43) Pub. Date: Nov. 3, 2005

(54) Apparatus for pipeline isolation

(76) Inventors: Ciaran Early, Dublin (IE); Eric Gage, Houston, TX (US); Douglas McTavish, Stavanger (NO); James Early, Dublin (IE)

Correspondence Address: GABLE & GOTWALS, 100 WEST FIFTH STREET, 10TH FLOOR, TULSA, OK, 74103, US

(21) Appl. No.: 10/503,822

(22) PCT Filed: Feb. 10, 2003
(86) PCT No.: PCT/IE03/00019

§ 371 Date: Jun. 16, 2005

(30) Foreign Application Priority Data
Feb. 8, 2002 (IE) S020089

(51) Int. Cl. F16L 55/10

(52) U.S. Cl. 138/89

(57) ABSTRACT

An apparatus for pipeline isolation comprising a pipeline isolation tool (1) having a cylindrical vessel with locking grips (21) and sealing member (19) encircling the cylindrical vessel. The locking grips (21) and sealing members (19) are operable by a hydraulic piston (10) contained within a core of the cylindrical vessel and a hydraulic pump for operating the piston (10). The piston (10) is a double rodded acting piston (10) comprising an elongated shaft and a head centrally located on the shaft so that the volume swept by the piston (10) is equal in both directions. A control module (32) is connected to the isolation tool (1) at one end and a gauging tool (33) is connected to the other end of the isolation tool (1).

The present invention relates to an apparatus for pipeline isolation and in particular to an apparatus for plugging high interior pressure pipelines.

Oil and gas are useful and expensive commodities that are transported from source to secondary locations using long lengths of pipe known as pipelines. Generally throughout the lifetime of the pipeline, repairs or replacement of sections must occur. However some if not all of the pipelines are situated entirely or in part in a difficult working environment, for example on the seabed. This fact encompassed with high pressured pipeline interiors meant that pipeline isolation was a difficult and arduous task, as traditionally pipelines requiring isolation had to be depressurised prior to any work commencing.

U.S. Pat. No. 4,332,277 discloses the Wittman tool which enables isolation of a high pressure pipeline. It is therefore unnecessary to depressurise an entire pipeline resulting in significant cost savings by the pipeline owners.

However, there is a significant disadvantage to the Wittman tool. The tool “control function” is conducted using a hydraulic tether. The hydraulic tether only functions effectively using a short range hydraulic control umbilical. This prevents the Wittman tool from venturing great distances into the pipeline. Thus the tool is operated close to the beginning or end of the pipeline.

Recent developments in magnetics technology enabled “through the pipeline wall” communication using Extremely Low Frequency (ELF). ELF is based on excitation and detection of low frequency magnetic fields. Magnetic waves or fields are found at the lower end of the frequency spectrum between O Hz and 300 Hz.

Extremely Low Frequency (ELF) magnetic waves are found at the lower end of the magnetic frequency spectrum and can be used to penetrate through Carbon Steel, concrete earth, water etc. independently of most physical mediums between transmitter and receiver. ELF has not been used extensively by the military for signal traffic because its data transmission rate is too slow. Some ELF technology remained classified by the military until the mid 90's.

Very Low Frequency communications (VLF) using magnetic waves or fields have been used for over forty years as a method for transmitting messages to and from submarines. For example, shoreside VLF transmitters based in the United Kingdom can broadcast signal traffic to submarines based in Singapore provided the submarine is fitted with a VLF aerial and is trailing at a shallower depth than 25 feet or is manoeuvring at periscope depth.

Ultra Low Frequency (ULF) enabled the US to adopt a more sophisticated broadcast network as part of the US Sanguine operation, where two transmitters with enormous aerial systems were maintained. The two transmitters could broadcast ULF signals to US fleet submarines at deeper depths worldwide.

ELF communication techniques enabled the development of autonomous pipeline isolation tools (plugs) that do not require an umbilical tether, thus allowing remote isolation of a pipeline at any chosen location along that pipeline, even hundreds of miles away from the isolation tool's initial launch point. The command functions carried out by the isolation tool, such as locking, monitoring and unlocking are carried out by an ELF communication system operating through the pipeline wall.

Despite this there are problems associated with the autonomous pipeline isolation tool. Initially most tools contain a conventional piston within the isolation tool, whereby the rod side of the piston has a lesser volume than the flat side of the piston. This imbalance within a closed hydraulic system requires installation of an accumulator or other compensating device to house the additional oil volume presented by having a rod on one side of the piston and no rod on the other side of the piston.

A further problem occurring is the inability to check that the isolation tool will reach the desired location prior to an isolation operation commencing without using a separate dedicated gauging tool. It is costly to employ a separate dedicated gauging tool to determine that the internal pipeline geometry is sound and free, but it is also costly if during an operation it is discovered that the internal pipeline geometry is unsound and is blocked by an obstruction. Secondly, in order to ensure that an isolation tool can be recovered from a failure or “dead ship” situation, it is necessary to install a master dump valve. Whilst it is essential to incorporate the master dump valve, it is extremely undesirable as it competes for space within the isolation tool. Thirdly, smaller pipelines prove to be more difficult to build isolation apparatus for, as the electronic and hydraulic controlling components must be enclosed within reduced pressure vessel containers.

It is an object of the present invention to seek to alleviate the aforementioned problems.

Accordingly, the present invention provides an apparatus for pipeline isolation composing a pipeline isolation tool having a cylindrical vessel with locking grips and sealing members encircling the cylindrical vessel and being operable by a hydraulic piston contained within a core of the cylindrical vessel and a hydraulic pump for operating the piston wherein the piston is a double rodded acting piston comprising an elongated shaft and a head centrally located on the shaft so the volume swept by the piston is equal in both directions.

Preferably, a control module is connected to the isolation tool at one end thereof.

Ideally, a plate member is provided on the control module and a master dump valve is incorporated into the plate member.

Preferably, a trigger spool valve is incorporated into the plate member in order to prevent the master dump valve from operating until the isolation tool is at a final destination point within the pipeline.

Ideally, the trigger spool valve is driven from a pilot line on the hydraulic pump which is activated when the isolation tool reaches its final destination point, thereby pressurising the pilot line and driving the trigger spool valve away from the master dump valve allowing the master dump valve to activate in response to a pressure spike.

Preferably, the attached control module has means for communication with a remote unit.

Ideally, the said control module is adaptable for use with a range of isolation tools having different external diameters.

Preferably, the actions of the double rodded acting piston are controllable by signals from the remote unit, the signals being communicatable through the pipeline to the control module using extremely low frequency magnetic waves.

Ideally, the magnetic waves are detectable and transmittable using an aerial array cluster.

Preferably, movement of the isolation tool during isolation is detected using scintillating detectors disposed in the remote unit, the scintillating detectors being tuned for frequency recognition of specific radioactive isotopes disposed in the control module.

Ideally, the remote unit is a programmable autonomous underwater vehicle (AUV) having an on-board ELF communications system.

Preferably, one end of the rod of the double-shafted piston is hollow.

Ideally, machined components of the apparatus are manufactured from titanium or a titanium alloy.

Preferably, a gauging tool is provided at the end of the isolation tool distal from the control module.

Ideally, two or more isolation tools are provided between the control module and the gauging tool.

The present invention also provides a control system for controlling the operation of an apparatus for pipeline isolation as outlined above, comprising a first module disposed in the control module including a first microcontroller for monitoring output values from pressure sensors, valve controllers, a hydraulic pump motor and power supplies, a second module disposed in a remote unit comprising a second microcontroller for monitoring output values from scintillating detectors, the first and second microcontrollers each having a communication means for communicating through a pipeline using ELF and the second module being capable of communicating with a remote command unit.

The present invention also provides a control program for controlling the system as outlined above, comprising interrogation means for monitoring output values received from the pressure sensors, the valve controllers, the hydraulic pump motor, scintillating detectors and the power supplies, interpretation means for analysing output values received from the interrogation means and means for generating and transmitting signals both in response to output values received from the interrogation means and in response to pre-programmed operating instructions to operate the valve controllers and the hydraulic pump motor to set and unset the isolation tool.

Preferably, the interpretation means further includes alarm-generating means operable if output values from the pressure sensors fall outside pre-programmed allowable bandwidths after the isolation tool is set.

Advantageously, front and rear portions of the isolation tool contain ball joint housings which enable attachment of further tools.

Advantageously, a gauging tool is attached to the isolation tool where the gauging tool contains gauge plates which record the geometry of the pipelines.

It is preferable for the gauging tool to carry gauging plates suitable for the particular pipeline being isolated and for the gauging plates to have geometry in excess of the isolation tools external diameter. Ideally, the gauge plates are configured to accommodate 92% of internal diameter of the targeted pipeline however the gauge plates can be made to accommodate an individual clients requirements. Ideally, the gauging tool is detached from the isolation tool prior to the isolation operation commencing and is deployed down the pipeline to confirm that the internal pipeline is sound and free from obstruction.

Preferably, the gauging tool is recoupled with the isolated tool prior to the pipeline isolation operation commencing.

Ideally, the isolation apparatus is conveyed to the isolation point in a “train” by the movement of a fluid within the pipe. Advantageously, the “train” comprises a gauging tool, one or more isolation tools and a control module. Ideally, once the isolation tool or tools are at the isolation site, a command system in combination with a communication system external to the pipeline communicates with the control module inside the pipeline using ELF techniques.

Ideally, the remote unit activates the double-action or double-shaft piston and the plugging members are engaged provided conditions within the pipeline are appropriate. Advantageously, the double action piston is readily adaptable to suit a wide range of sizes of isolation tools. Advantageously, the isolation tool is also readily adaptable to accommodate pipelines with various internal diameter sizes. For example, pipeline internal diameters generally range from 0.30 m to 1.07 m and the isolation tool can be made to specific requirements. Ideally, the same control module can be adapted to various sized isolation tools.

The invention will now be described more particularly with reference to the accompanying drawings, which show by way of example only several embodiments of an isolation tool of the invention.

### In the drawings,

FIG. 1 is a cross-sectional side view of a first embodiment of an apparatus according to the invention;

FIG. 2 is a cross-sectional side view of a first embodiment of an isolation tool;

FIG. 3 is a cross-sectional side view of the first embodiment of isolation tool in an unset configuration within a pipeline;

FIG. 4 is a cross-sectional side view of the first embodiment of isolation tool in a partially set configuration within a pipeline;

FIG. 5 is a cross-sectional side view of the first embodiment of the isolation tool in a fully set configuration within a pipeline;

FIG. 6 is a perspective view of a plate member of the control module;

FIG. 6a is an end view of the plate member of FIG. 6;

FIG. 6b is a perspective view of a master dump valve within the plate member of FIG. 6;

FIG. 7 is a cross-sectional end view of the master dump valve of FIG. 6 in an unset position prior to operation;

FIG. 7a is a cross-sectional end view of the master dump valve of FIG. 6 in a partially set position during operation;

FIG. 7b is a cross-sectional end view of the master dump valve of FIG. 6 in a set position during operation;

FIG. 7c is a cross-sectional perspective view of the master dump valve of FIG. 6 in a set position during operation;

FIG. 8 is a perspective view of a pressure head support disk;

FIG. 8a is an end view of the pressure head support disk of FIG. 8;

FIG. 9 is a cross-sectional side view of a second embodiment of an isolation tool;

FIG. 10 is a cross-sectional side view of a double shafted piston;

FIG. 11 is a perspective view of the first embodiment of isolation tool as shown in FIG. 2;

FIG. 12 is a perspective view of a third embodiment of isolation tool;

FIG. 13 is a schematic drawing of a command system, a communication system and a control system of the apparatus; and

FIG. 14 is a schematic diagram of an electronic circuit board for a transceiver.

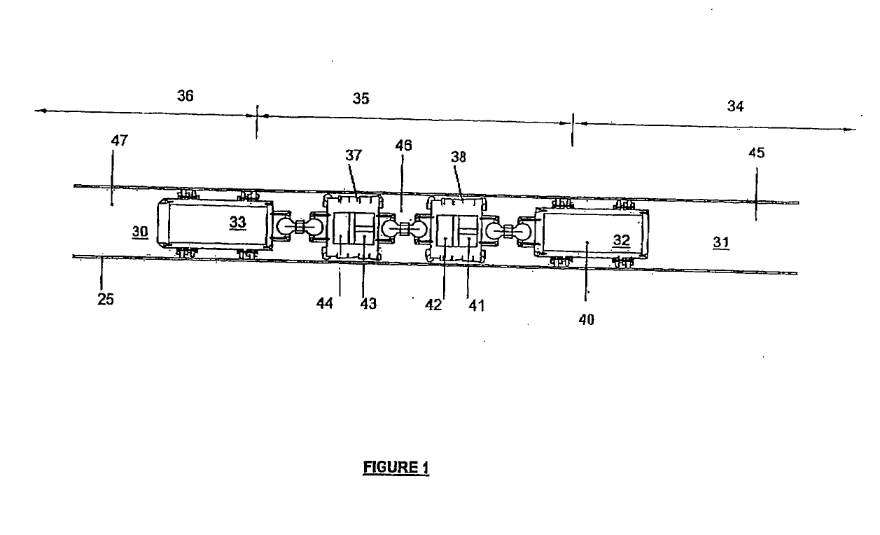

Referring initially to FIG. 1, there is shown a cross-sectional side view of a preferred embodiment of the apparatus of the invention comprising four modules in a train where the front end first module is a gauging tool 33, the second and third modules are isolation tools 37 and 38 respectively and the rear end fourth module is a control module 32. The gauging tool 33 is the first module to travel downstream 36 at the beginning of a pipe isolation project, into a region of high pressure 30. The gauging tool 33 houses gauge plates which will confirm if the pipeline geometry is negotiable prior to launching the isolation tools 37 and 38 respectively. The gauging tool 33 is uncoupled from the train and launched down the pipeline on it's own. The gauging tool 33 is then recovered further down the line (or recovered to the launcher) and the recovered gauge plates are examined. Once it is decided that the line is clear and the train can reach the isolation location, the gauging tool 33 is re-coupled to the train and the train is launched.

There are pressure transmitters located on the train within the pipeline. The pump pressure transmitter is situated on the control module 32. There are pressure transmitters 41-44 on the isolation tools 37 and 38 respectively. Essentially these pressure transmitters 41-44 record and transmit the pressure of the double-shafted hydraulic piston in the set and unset positions. Pressure transmitters 41 and 43 record and transmit the pressure of the double shafted hydraulic piston in the set position and pressure transmitters 42 and 44 record and transmit the pressure of the double shafted hydraulic piston in the unset position on isolation tools 37 and 38 respectively.

There are further pressure transmitters located on the train in the pipeline. When the train is in the pipeline it is possible to measure the pressure downstream 36, the annulus pressure 35 and upstream pressure 34 from the train. In this particular example, the downstream pressure is recorded and transmitted by pressure transmitter 47, whilst pressure transmitters 46 and 45 record and transmit the annulus and upstream pressures respectively.

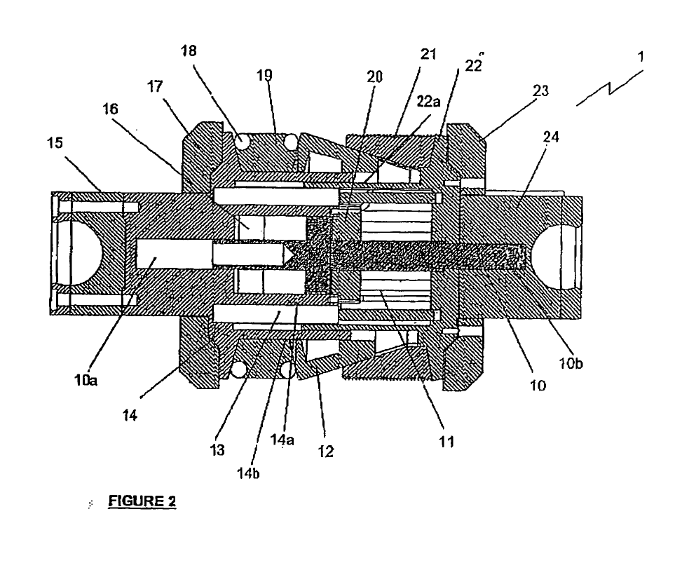

The operation of isolation tools 37 and 38, and control module 32 shall be explained clearly with reference to FIGS. 2-12 and FIGS. 13-14 respectively.

FIG. 2 is a cross-sectional side view of a first embodiment of an isolation tool 1. The isolation tool 1 comprises a closed hydraulic system, ball joint housings 15 and 24 at the forward and rear ends respectively, a pressure head 14, a pressure head support disk 17, a packer seal 19, a grip bearing ring 12, a grip segment 21, an actuator flange 22 and an actuator flange support disk 23. The closed hydraulic system comprises a double shafted hydraulic piston 10, return spring centralising pins 11, return spring receptacle 13, a cylinder head 20, piston cylinder 16 and a radioactive isotope (not shown) is located in the isolation apparatus for detection purposes.

The closed hydraulic system is centrally situated within the isolation tool 1. The front 10a of the double shafted hydraulic piston 10 is encased by the pressure head 14, which has two protruding members which extend rearwardly encasing the forward half of the closed hydraulic system. The first protruding member 14a is positioned between the piston cylinder 16 and the return spring receptacle springs 13, whilst the second protruding member 14b is positioned outside the outer return spring receptacle springs 13 and the forward protruding member 22a, and is enclosed by both the packer seal 19 and the grip bearing ring 12. The pressure head 14 has a ball joint housing 15 attached to the forward side. The pressure head 14 is held securely in position by the pressure head support disk 17. The rear 10b of the double shafted hydraulic piston 10 is encased by both the actuator flange 22 and the rear ball joint housing 24. The actuator flange 22 has a forward protruding member 22a which encases the rearward half of the closed hydraulic system. The forward protruding member 22a is positioned such that it is outside the return spring receptacle springs 13 and inside the second rearwardly protruding member 14b.

The actuator flange 22 is held securely in position by the actuator flange support disk 23. Further support is provided to the actuator flange 22 and the grip bearing ring 12 by the grip segment 21. The isolation tool 1 is launched down the pipeline and propelled by fluid to the required location.

The movement of the isolation apparatus is monitored and detected using ELF techniques. A battery powered ELF pinger is placed inside a control module. The position of the isolation apparatus inside the pipeline is located by searching with an ELF detector on the outside of the pipeline for the ELF pinger inside the pipeline. The precise location of the isolation apparatus can be detected due to the fact that the ELF signal decays rapidly with distance. The closer the pinger is situated to the aerial placed outside the pipeline, the stronger the ELF signal received by this aerial. This means that the pinger cannot be detected until the distance between the pinger and receiver is less than around 4-10 metres, depending on background noise conditions. Once at the desired location, the isolation tool 1 is remotely operated to plug the pipe, (this requires a far more sophisticated transmitter, receiver which will be discussed fully later). Remote commands mechanically engage a motor driven pump which pressurizes fluid contained within the closed hydraulic circuit. This fluid is used to move the double shafted hydraulic piston 10 in one direction to set the isolation tool 1 and to move the double shafted hydraulic piston 10 in the other direction to unset the isolation tool 1.

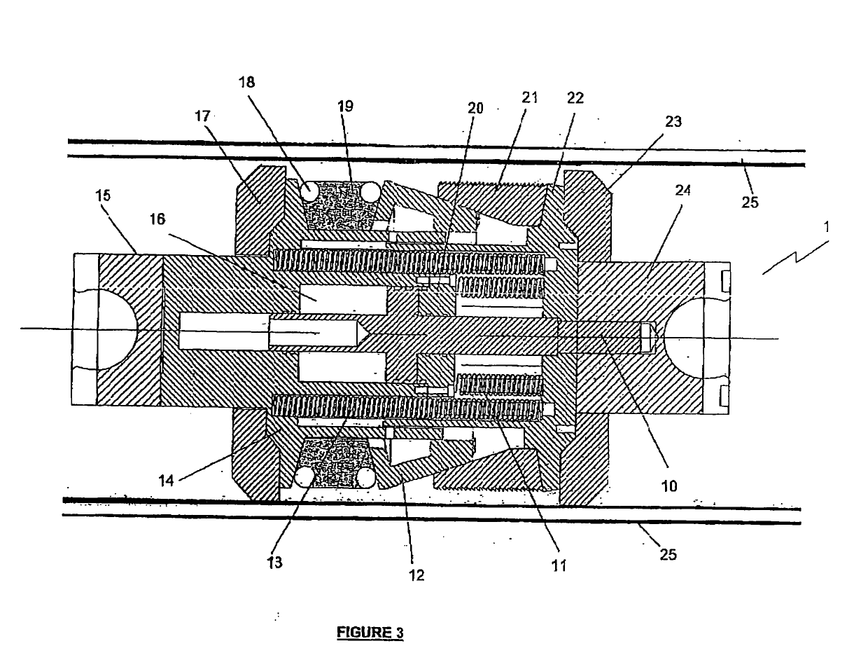

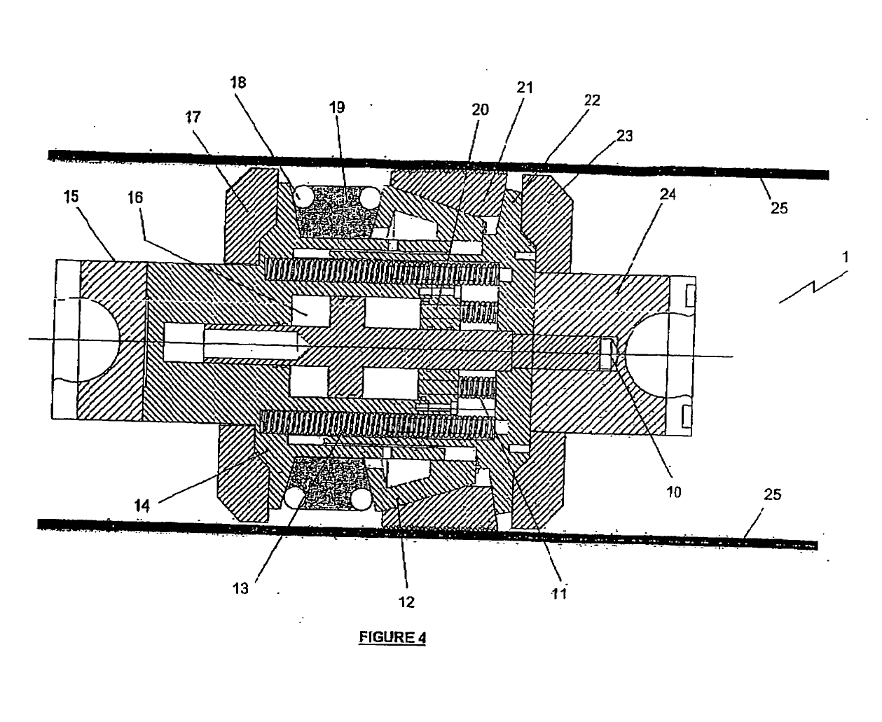

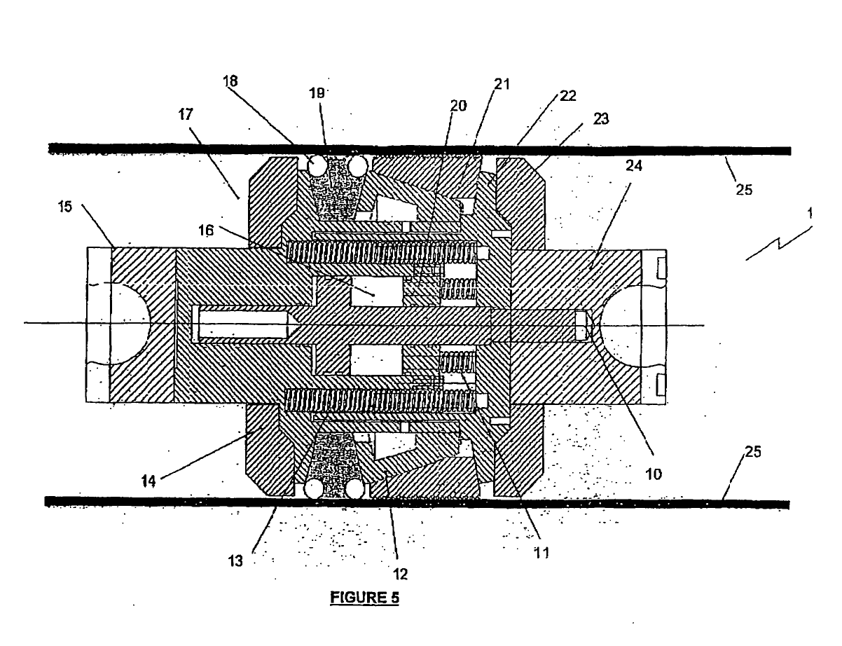

FIGS. 3 to 5 provide detailed cross-sectional side views of the first embodiment of the isolation tool 1 of FIG. 2 in an unset, partially set and fully set configuration within the interior of a pipe. In FIG. 3, the isolation tool 1 is in an unset configuration and sits on the lower surface of the pipe wall 25. The double shafted hydraulic piston 10 engages forcing the return springs held on the return spring centralising pins 11 into a compressed position. FIG. 4, shows the grip segment 21 which encircles the isolation tool 1 being forced into contact with interior circumferential surface of the pipe wall 25 as the springs compress. The grip segment 21 is the only member of the isolation tool 1 in contact with the interior circumferential surface of the pipe wall 25 in this partially set configuration. FIG. 5 shows further compression of the return spring receptacle springs 13. This forces the packer seal 19 into contact with interior circumferential slice of the pipe wall 25. The piston geometry was redesigned such that the double shafted hydraulic piston 10 had a rod on both sides of the piston face, thus bringing the piston into fluid balance. The rod hollowed out of the forward end 10a (see FIG. 2) of the double shafted hydraulic piston 10 enables the trapped gas to be compressed into a cavity of much greater volume than in the prior art.

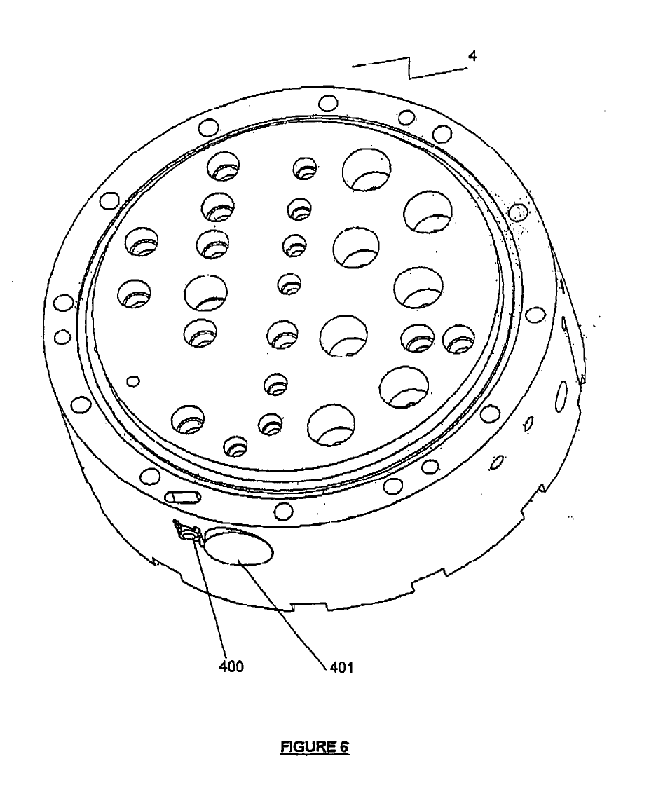

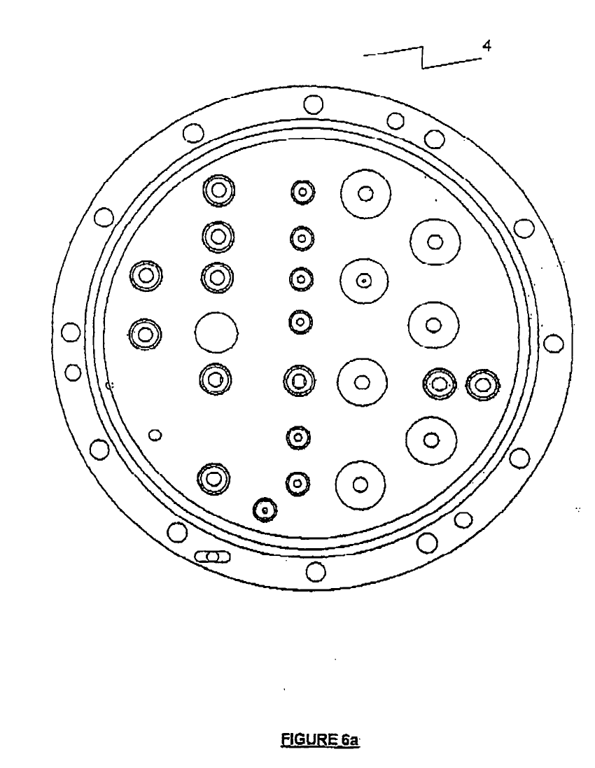

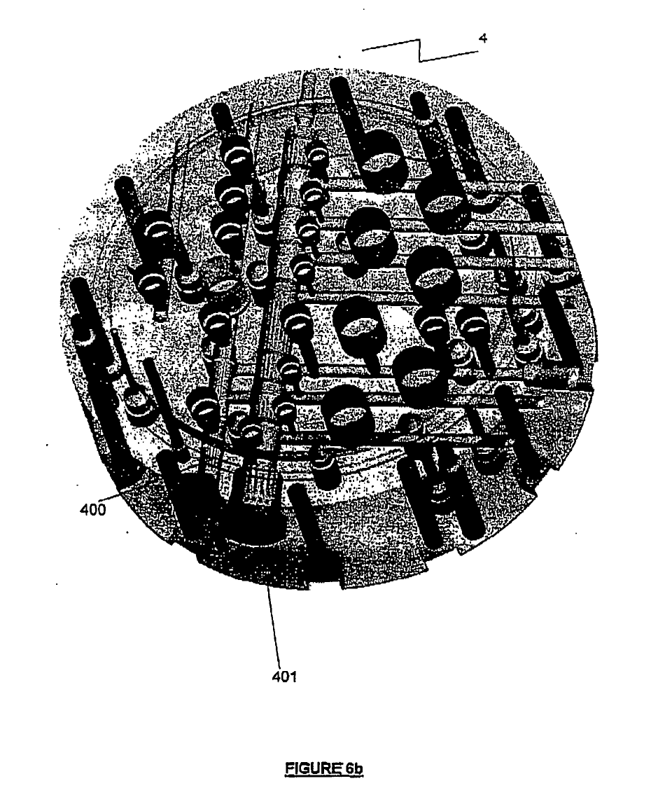

FIGS. 6 and 6a are perspective and end views respectively of the plate member 4, where the plate member 4 has a built in master dump valve 401. FIG. 6b is a perspective view of the master dump valve 401 within the plate member 4. All of the hydraulic and annulus fluid pipework must penetrate the plate member 4, thus considerable space is saved within the isolation tool 1. The master dump valve 401 operates on the ‘pressure spike’ principle. Once the pressure increases to a level that is equal to or greater than a preset value in excess of the pipelines operating pressure, the master dump valve pressure relief valve senses it and activates the master dump valve 401.

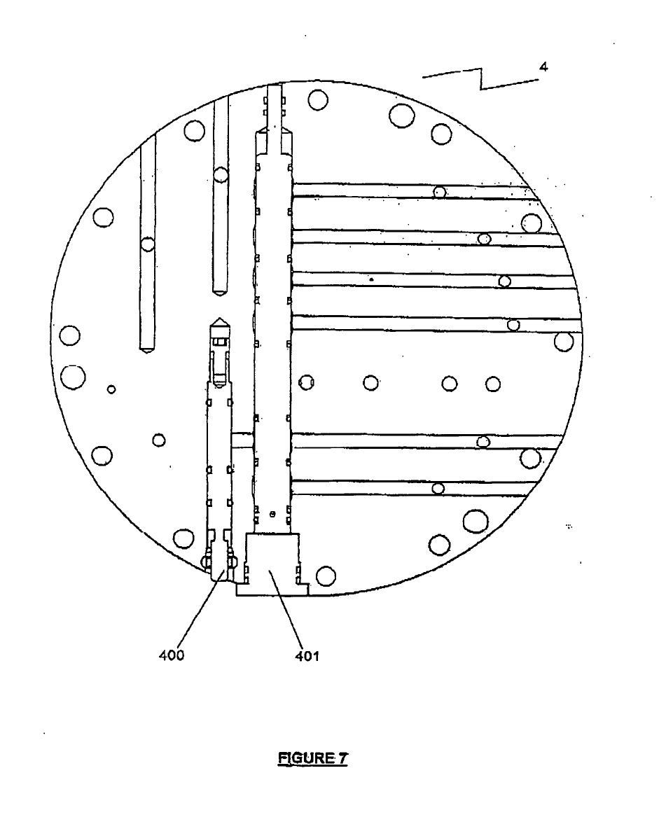

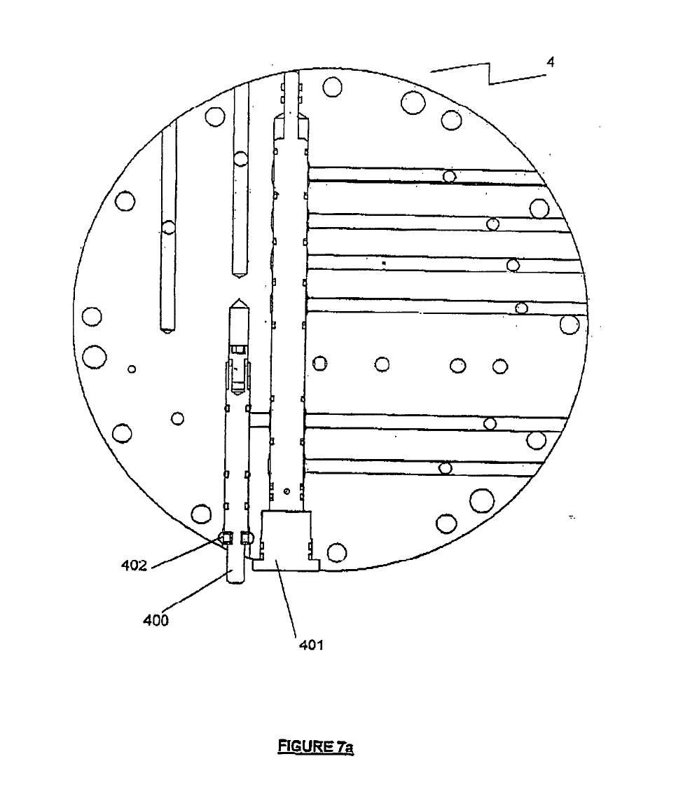

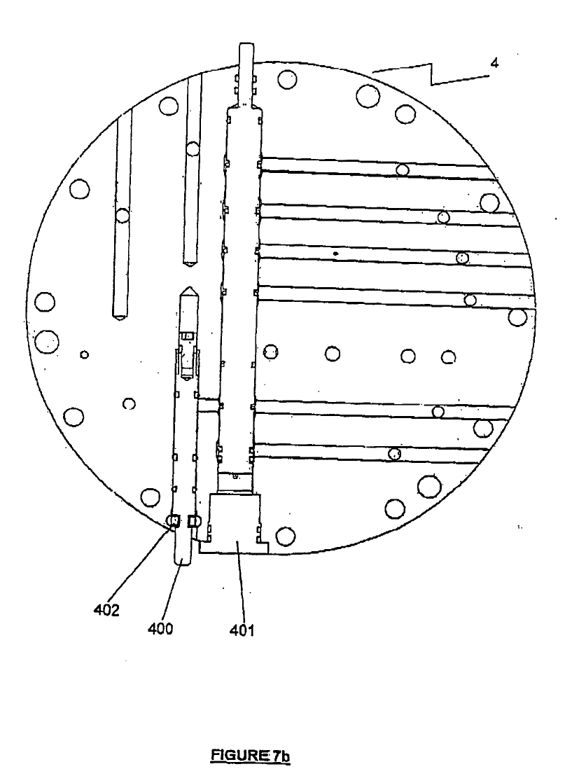

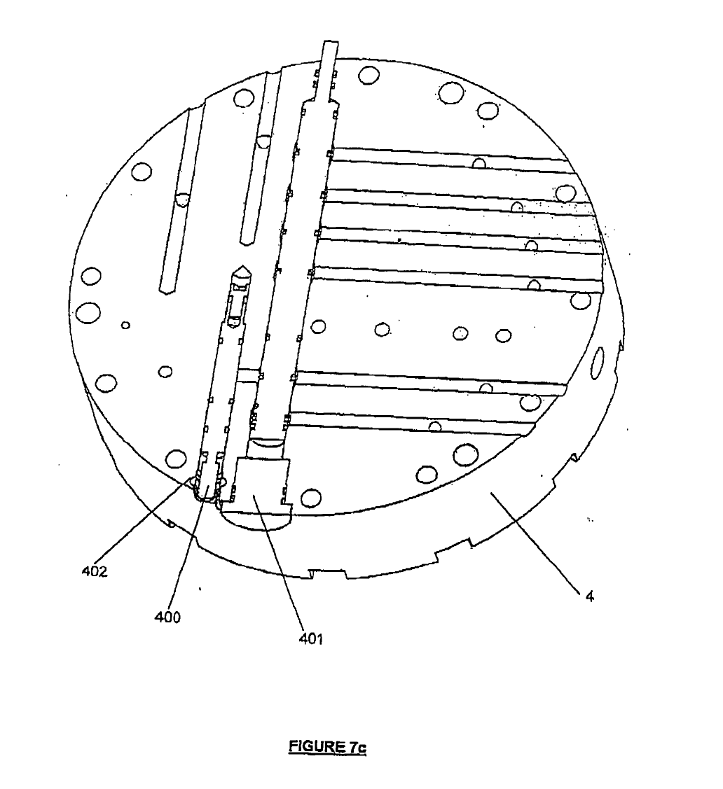

It is possible for the remotely operated isolation apparatus to get caught on a weld head or some other obstruction projecting from inside the pipeline. Such a stoppage could cause a pressure spike in the propelling fluid behind the isolation apparatus which in turn would cause the activation of the master dump valve 401. In order to prevent the master dump valve 401 from operating inadvertently an additional trigger spool valve 400 blocking the sensor is provided. FIGS. 7 to 7c are cross-sectional end views of the master dump valve 401 and trigger spool valve 400 positioned within the plate member 4, where the master dump valve 401 and trigger spool valve 400 are in pre activation, partial activation and post activation settings. FIG. 7 shows the trigger spool valve 400 built into the sliding spool 404 of the master dump valve 401. The trigger spool valve 400 prevents the sliding spool 404 of the master dump valve 401 from moving until the isolation tool 1 is at the final destination point within the pipeline.

The trigger spool valve 400 is driven from a pilot line on the hydraulic pump. FIG. 7a shows the movement of the trigger spool valve 400 on activation of the hydraulic pump. Once the hydraulic pump is activated, it pressurises a pilot circuit which drives the trigger spool valve 400 away from the sliding spool 404 of the master dump valve 401. The trigger spool valve 400 is then itself locked by a spring loaded latching detent 402. Once the trigger spool valve 400 is latched, the sliding spool 404 of the master dump valve 401 is free to operate, should it see a pre-determined pressure spike increase above pipeline operating pressure. FIGS. 7b and 7c show the position of the sliding spool 404 of the master dump valve 401 once it is operational. The operational position of both the sliding spool 404 of the master dump valve 401 and the trigger spool valve 400 cause end pieces to project beyond the circumferential rim of the plate member 4. The end pieces are protected by other members of the isolation tool 1 that have a diameter that is greater than the diameter of the combined plate member 4 and end pieces of the sliding spool 404 of the master dump valve 401 and the trigger spool valve 400.

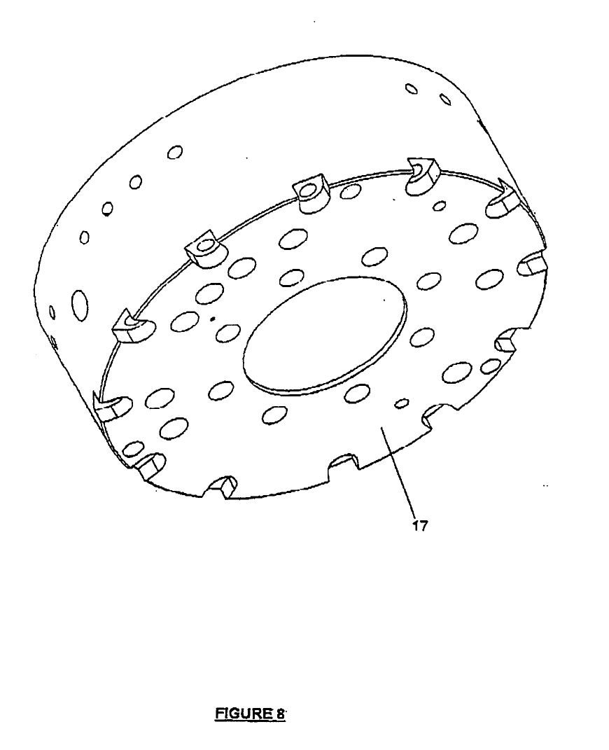

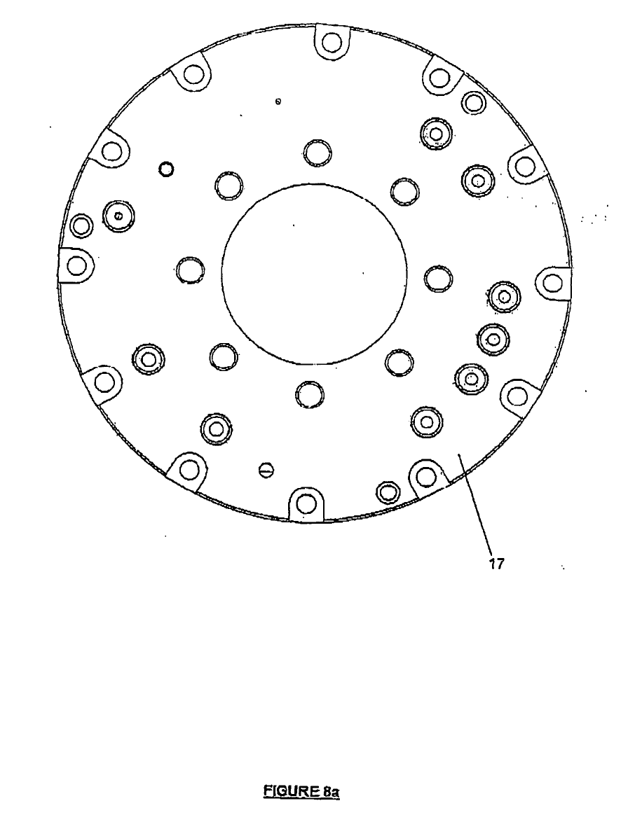

FIGS. 8 and 8a are perspective and end views respectively of the pressure head support disk 17 which is positioned on the isolation tool 1 remote from the plate member 4.

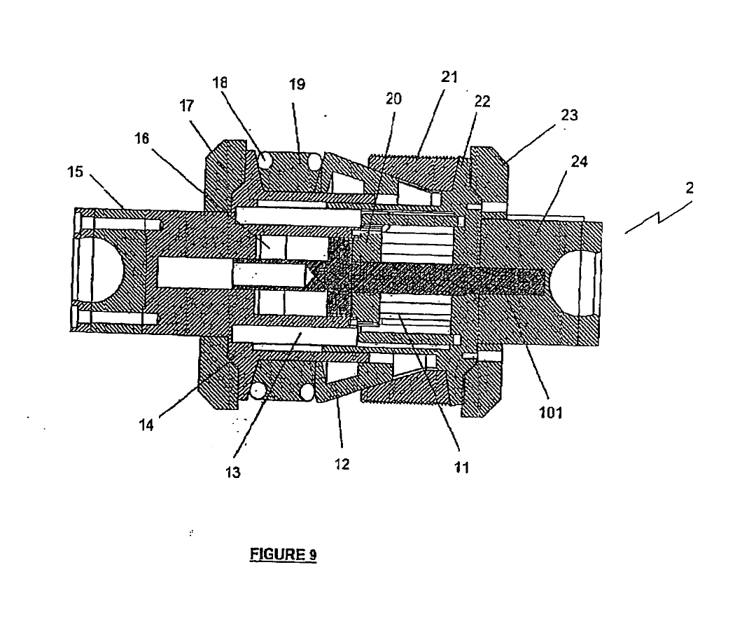

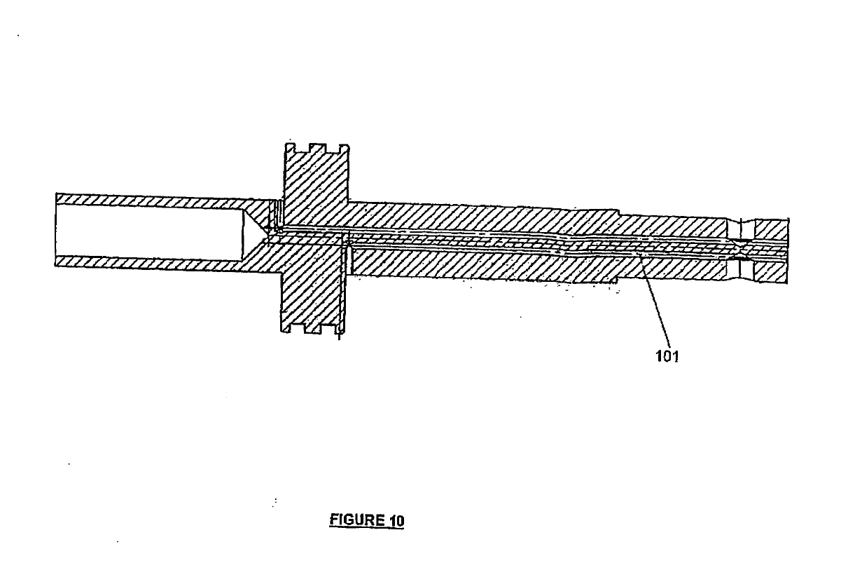

FIG. 9 is a cross-sectional side view of a second embodiment of isolation tool 2 showing the shape of the double shafted hydraulic piston 101. FIG. 10 is a magnified cross-sectional side view of the double shafted hydraulic piston 101, which operates as previously described.

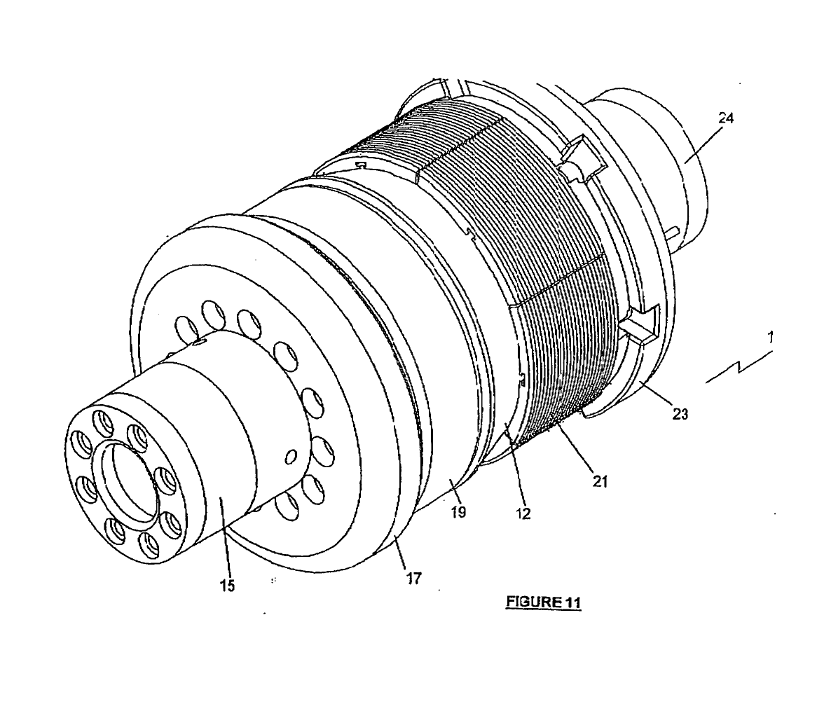

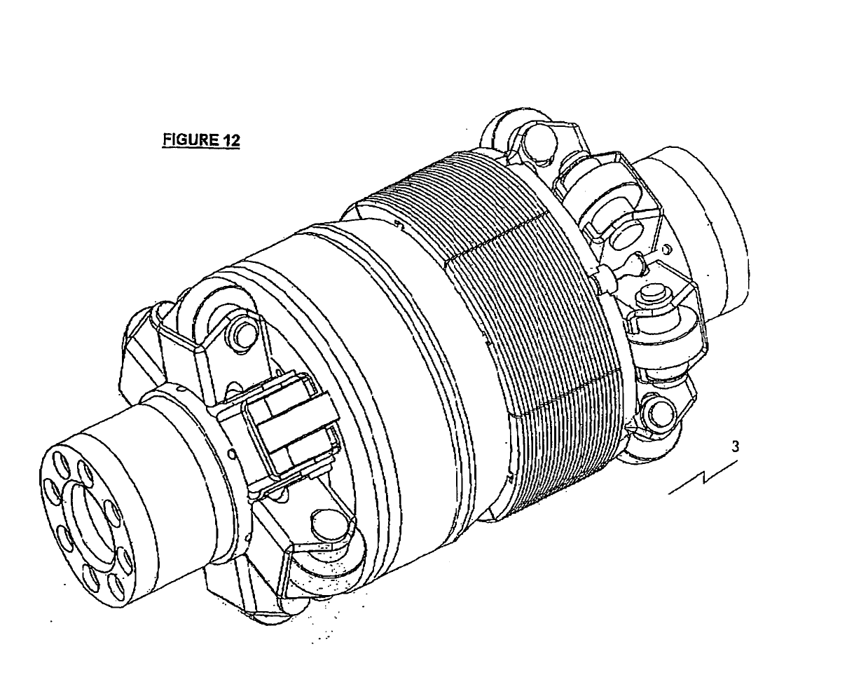

FIGS. 11 and 12 are perspective views of the isolation tool. FIG. 11 shows the preferred embodiment of the isolation tool 1, where the pressure head support disk 17 and the actuator flange support disk 23 extend beyond the width of the main body of the isolation tool 1 providing a measure of protection for the isolation tool 1 as it traverses through the pipeline.

FIG. 12 is a perspective view of the third embodiment of isolation tool 3. The support disks do not extend beyond the width of the main body of the isolation tool 3. Instead protection for the sides of the isolation tool 3 is provided by a circular ring of sprung wheels, at the front and rear of the isolation tool 3.

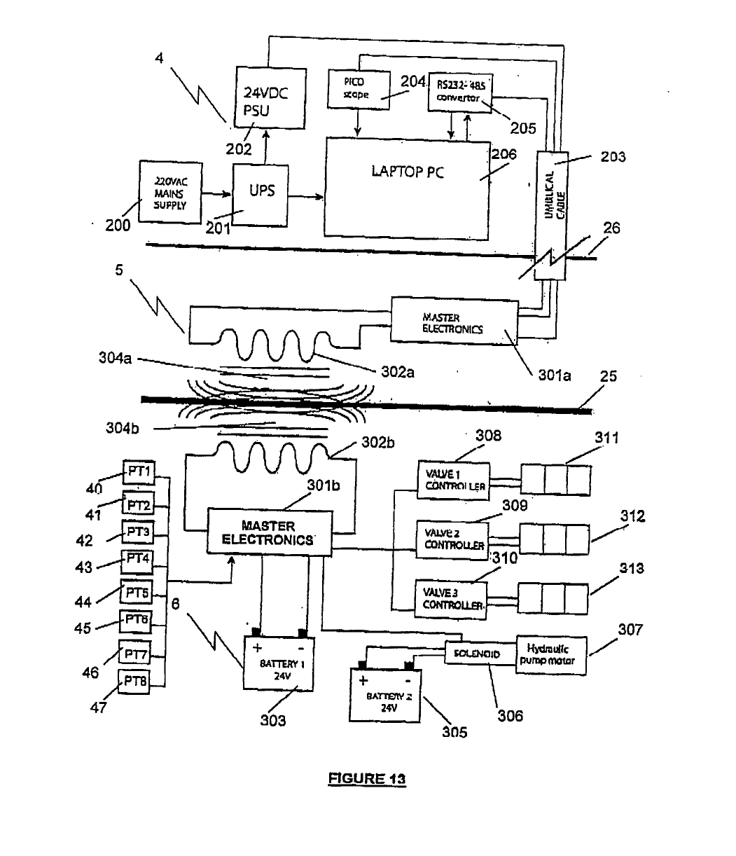

FIG. 13 is a schematic drawing of the command system 4, communication system 5 and control system 6 of the apparatus. A remotely operated isolation tool 1, (see FIG. 2) is transportable down a sub-sea pipeline for distances up to and greater than 100 km. It is then autonomously operated to safely seal the product inside the downstream side of the pipeline, prior to intervention works taking place on the upstream side of the pipeline isolation. The System is structured as follows:
Command System 4—positioned on a vessel above the sea or remotely located on the shore
Command System 5—positioned on top of the pipeline in use
Control System 6—positioned in control module 32, inside the pipeline in use

All operations of the isolation tool (1) are controlled by a computer 206 running software that sends commands and receives readings via the communication system 5 comprising first electronics module 301a and first aerial 302a disposed in a remote unit outside the pipeline and second electronics module 301b and second aerial 302b disposed in the control module (32) of the isolation apparatus train inside the pipeline. The computer 206 is located on a surface vessel and is connected to the first electronics module 301a through an RS485 adaptor 205 and a sub-sea umbilical cable 203. Alternatively, the computer 206 is located on land and signals are transmitted to the first electronics module 301a of the communication system 5 via acoustic signal transmission technology.

The command system computer 206 is mains powered 200 and 201. The command system 4 also sends 24v DC 202 down the sub sea cable 203 to the first electronics module 301a of the communication system 5. The first electronics module 301a and first aerial 302a of the communications system 5 is placed outside the pipeline and is precisely positioned using scintillating detectors to enable the matched aerial 302a to communicate optimally with the matched aerial 302b inside the pipeline. The aerial 302a comprises a cluster of coils, which form an array as a greater collective transmission source is easier to receive (in magnetic terms) by the matched aerial 302b inside the pipeline and also a greater collective receiver system is beneficial to the single aerial 302b transmitter.

Scintillating detectors determine exact positioning of the isolation apparatus inside the pipeline. These are configured for the isotopes (an example of isotopes used are Tantalum 182, Iridium 192 or Cesium 137) normally used in isolation apparatus. The scintillating detectors are incorporated inside the aerial array 302a in pre-defined “optimum” geometry, which facilitates “best transmission and reception” for the communication system 5 and control system 6. The scintillating detector system is configured with a twin scintillating detection system so that any movement of the radioactive isotope in the isolation apparatus is detected. One detector is always looking at a shining source, and the second detector is one metre away looking at a “non shining” source. Should the apparatus move, then the first detector loses its signal and the second detector gains a signal. This method gives positive indication that the isolation apparatus has moved.

Alternatively, detectors are hired from third party companies. These units comprise specialist equipment, which are lowered to the seabed onto the pipeline and are moved around by divers or alternative methods to positions which are beneficial to the external aerial 302a array.

Optimum positioning is achieved by the aerial system's “in built” scintillating detectors locating on the radiating isotope located in the control module (32). The communications system 5 contains an ELF transceiver comprising first electronics module 301a and first aerial 302a for communication with the transceiver of the control system 6 comprising second electronics module 301b and second aerial 302b. Control system 6 for the isolation apparatus is located inside a one-atmosphere pressure vessel 17, (see FIG. 8) which is located in the control module (32). Through ELF communications, instructions are transmitted and received to operate the hydraulic pump system 307 to SET or UNSET each of the isolation tools. The control system 6 also sends information on the communication system 5 regarding valve positions 308-310, pressure sensor readings 40-47 as well as any alarm status. The control system 6 enables bandwidths to be set to initiate an alarm, should pressures move outside defined limits, after the isolation tool (1) is SET.

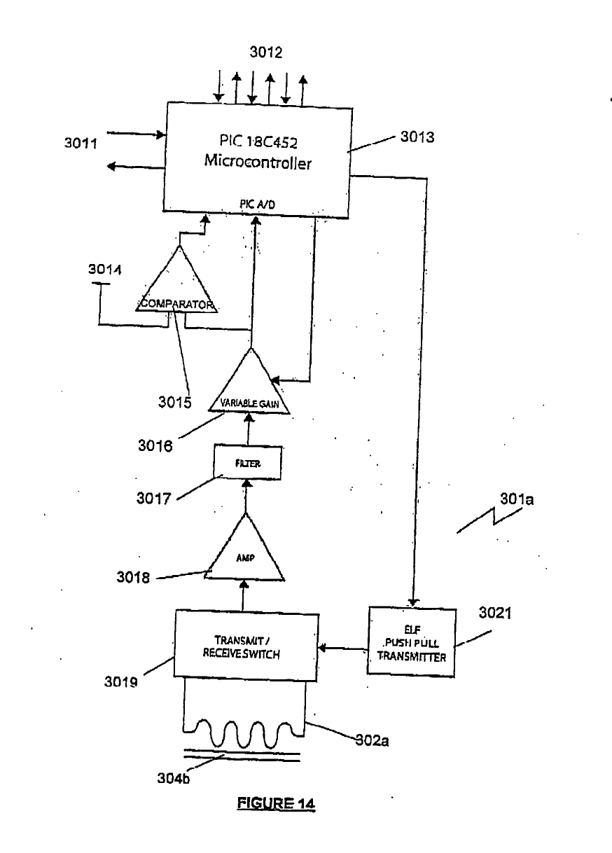

FIG. 14 is a schematic diagram of an electronic circuit board 301b for transmitting and receiving ELF signals. Central to the electronic circuit board 301b is a PIC18C452 micro-controller 3013. This device has built in RAM, ROM and IO. It also has several built in peripherals including a 12C master module, a USART and analogue to digital converter. The 12C protocol is used for communications with local devices on the Printed Circuit Board (PCB) 301b. The 12C devices on the PCB 301b include an 8-channel 12-bit A/D converter 3011, a real time clock, a non-volatile EEPROM, a 4-channel digital potentiometer and an 8-bit 4-channel D/A converter 3012.

The micro-controller 3013 uses its USART to communicate with the valve controllers through an RS232 interface device and communicates with external devices through an RS485 interface device. The pressure transmitters have a 4 to 20 mA interface and are read using the 12C 8-channel 12-bit A/D converter 3011. The ELF transceiver circuit consists of a push-pull transmitter 3021 and a high gain receiver 3019. The ELF transmitter 3021 is a FET transistor driven digital bridge circuit, which drives current through the transmitter coil in the direction and speed determined by the micro-controller 3013 using two I/O lines. A range of frequencies or phase modulation can be achieved by the micro-controller by changing the delay between each toggle of the I/O lines.

The ELF receiver circuit takes the signal picked up by the aerial 302b, amplifies it using amplifier 3018 and uses various band pass filters 3017 to remove un-wanted signals. To adapt to different environments and signal strengths, the micro-controller 3013 can adjust the amplifier gain 3016 from 0 to −80 dB using the 12C 4-channel digital potentiometer. The resulting signal is fed into an A/D channel in the micro-controller 3013, which is used to monitor signal levels. The signal is also fed into a comparator 3015 set for zero cross over detection. The resulting signal is a digital representation of the ELF signals received, and the output is fed into one of the micro-controller's I/O ports for interpretation by software.

Ideally the command system software runs on an IBM compatible PC with the Microsoft Windows XP operating system. The software is written in Visual C++ and uses standard Microsoft objects and foundation classes. The software has a visual front with mouse and keyboard feedback. Microsoft windows and Visual C++ are event driven and react to keyboard, mouse and communications port events. The Command System software is embedded in the micro-controller. All functions are written in ANSI compliant C and compiled using the Microchip MCC18 compiler. For flexibility and ease of maintenance, the Control System PCB and software are identical. Changing the digital state of the mode pin on the PCB is all that is required to change the mode of operation. A very simple Frequency Shift Keying (FSK) method has been implemented, in that “1” is transmitted as one cycle of a 12 Hz wave, and a “0” is transmitted as one cycle of a 6 Hz wave. This coding method works well and is extremely simple to decode accurately.

If the ELF receiver, the incoming signal must be decoded to determine the message content in terms of “0”s and “1”s. This is done as follows:
a. The incoming ELF signal is hard limited by using maximum amplifier gain.
b. The time between each zero crossing of the signal is measured.
c. The bit type is determined by timing the period between each zero crossing.

This very simple method implies that the transmitter and receiver antennas 302a, 302b should be oriented and aligned in phase. This does not present any problem in practical application, as the direction of the isolation tool in the pipeline is known, as is the polarity of the external antenna.

Each ELF message is made up of only 3 bytes, but in order to prevent erroneous communication, extra bit packing is added at transmission. The receiver micro-controller checks for a valid packet each time a bit is received. In order for the message to be processed, the packet must start with 7 1-bits and end with 7 0-bits. The data bytes are accompanied by a Cyclical Redundancy Check (CRC) that must match the CRC calculated by the receiver. In order to prevent random data generating a start and stop sequence, the data bytes and CRC are split up into nibbles and separated by a O-bit, 1-bit sequence. Steps are taken to ensure data integrity. The message format for the ELF communication link consists of a total of 64 bits organised as follows:
a. 7 consecutive 1-bits start pattern
b. A 0-bit, 1-bit nibble separator
c. Data byte 0 most significant nibble
d. A 0-bit, 1-bit nibble separator
e. Data byte 0 least significant nibble
f. A 0-bit, 1-bit nibble separator
g. Data byte 1 most significant nibble
h. A 0-bit, 1-bit nibble separator
i. Data byte 1 least significant nibble
j. A 0-bit, 1 bit nibble separator
k. Data byte 2 most significant nibble
l. A 0-bit, 1-bit nibble separator
m. Data byte 2 least significant nibble
n. A 0-bit, 1-bit nibble separator
o. CRC byte most significant nibble
p. A 0-bit, 1-bit nibble separator
q. CRC byte least significant nibble
r. A 0-bit, 1-bit nibble separator
s. 7 consecutive 0-bits stop pattern

The micro-controller has an interrupt service routine that processes all hardware interrupts. The ELF zero cross signal causes one of these interrupts and when it does, the time between this interrupt and the previous signal is calculated. Based on two time envelopes, a 0 or 1 bit is clocked into a 64 bit (8 byte) buffer organised as a shift register. The micro-controller does not count the bits received but just checks the buffer for a valid start, stop and nibble separators. After a valid packet has been received, a function extracts the data and CRC and goes on to process the message.

If a packet is received that is not valid or has some errors, the software will ignore it and will not transmit a response. A lack of response within a preset time is interpreted by the sender as Non Acknowledgment (NACK) and a re-transmission is attempted. When a valid packet is received a flag is set to inform a function running in the foreground that there is a command to execute. Once the command has been processed, an acknowledge message is transmitted back to the sender. The Acknowledgment (ACK) messages are in the same format as the command messages with three bytes and a CRC.

Due to the very low frequency used for ELF communication, the time to process messages and execute commands is negligible compared to the time required to transmit and receive each message. The messages/commands are sent from the command system 4, (FIG. 13) to the communication system 5, (FIG. 13) to the control system 6, (FIG. 13). The communication system 5 acts like an ELF modem. When it receives messages/commands intended for the control system 6, it will re-package these and transmit them over the ELF. The responses received from the control system 6 over the ELF or notification of lack of response are also passed back to the command system 4 via the communication system 5. The responsibility for re-transmission and ACK/NACK processing is the responsibility of the command system 4. The communication system 5 has two built-in scintillation detection devices. Special operator commands on the PC of the command system 4 are used to control and monitor these devices. The commands are processed internally and are not transmitted beyond the communication system 5 to the control system 6.

It will of course be understood that the invention is not limited to the specific details as herein described which are given by way of example only and that various alterations and modifications may be made without departing from the scope of appended claims.

1. An apparatus for pipeline isolation comprising a pipeline isolation tool (1) having a cylindrical vessel with locking grips (21) and sealing members (19) encircling the cylindrical vessel and being operable by a hydraulic piston (10) contained within a core of the cylindrical vessel and a hydraulic pump for operating the piston (10) wherein the piston (10) is a double rodded acting piston (10) comprising an elongated shaft and a head centrally located on the shaft so that the volume swept by the piston (10) is equal in both directions.

2. An apparatus as claimed in claim 1, wherein a control module (32) is connected to the isolation tool (1) at one end thereof.

3. An apparatus as claimed in claim 2, wherein a plate member (4) is provided on the control module (32) and a master dump valve (401) is incorporated into the plate member (4).

4. An apparatus as claimed in claim 3, wherein a trigger spool valve (400) is incorporated into the plate member (4) in order to prevent the master dump valve (401) from operating until the isolation tool (1) is at a final destination point within the pipeline.

5. An apparatus as claimed in claim 4, wherein the trigger spool valve (400) is driven from a pilot line on the hydraulic pump which is activated when the isolation tool (1) reaches its final destination point, thereby pressuring the pilot line and driving the trigger spool valve (400) away from the master dump valve (401) allowing the master dump valve (401) to activate in response to a pressure spike.

6. An apparatus as claimed in claim 2, wherein the attached control module (32) has means for communication with a remote unit (4).

7. An apparatus as claimed in claim 2, wherein the said control module (32) is adaptable for use with a range of isolation tools (1) having different external diameters.

8. An apparatus as claimed in claim 6, wherein the actions of the double rodded acting piston (10) are controllable by signals from the remote unit (4), the signals being communicatable through the pipeline to the control module (32) using extremely low frequency magnetic waves.

9. An apparatus as claimed in claim 8, wherein the magnetic waves are detectable and transmittable using an aerial array cluster (302a, 302b).

10. An apparatus a claimed in claim 6, wherein movement of the isolation tool (1) during isolation is detected using scintillating detectors disposed in the remote unit (4), the scintillating detectors being tuned for frequency recognition of the specific radioactive isotopes disposed in the control module (32).

11. An apparatus as claimed in claim 6, wherein the remote unit (4) is a programmable autonomous underwater vehicle (AUV) having an on-board ELF communication system (5).

12. An apparatus as claimed in claim 1, wherein one end of the rod of the double-shafted piston (10) is hollow.

13. An apparatus as claimed in claim 1, wherein machined components of the apparatus are manufactured from titanium or a titanium alloy.

14. An apparatus as claimed in claim 2, wherein a gauging tool (33) is provided at the end of the isolation tool (1) distal from the control module (32).

15. An apparatus as claimed in claim 14, wherein two or more isolation tools (1) are provided between the control module (32) and the gauging tool (33).

16. A control system (4, 5, 6) for controlling the operation of an apparatus for pipeline isolation as claimed in claim 1, comprising a first module disposed in the control module (32) including a first microcontroller for monitoring output values from pressure sensors (40 to 47), valve controllers (308, 309, 310), a hydraulic pump motor (307) and power supplies (303, 305), a second module disposed in a remote unit (4) comprising a second microcontroller for monitoring output values from scintillating detectors, the first and second microcontrollers each having a communication means for communicating through a pipeline using ELF and the second module being capable of communicating with a remote command unit.

17. A control program for controlling the system (4, 5, 6) as claimed in claim 16, comprising interrogation means for monitoring output values received from the pressure sensors (40 to 47), the valve controllers (308, 309, 310), the hydraulic pump motor (307), scintillating detectors and the power supplies (303, 305), interpretation means for analyzing output values received from the interrogation means and means for generating and transmitting signals both in response to output values received from the interrogation means and in response to pre-programmed operating instructions to operate the valve controllers (308, 309, 310) and the hydraulic pump motor (307) to act and unset the isolation tool (1).

18. A control program as claimed in claim 17, wherein the interpretation means further includes alarm generating means operable if output values from the pressure sensors (40 to 47) fall outside pre-programmed allowable bandwidths after the isolation tool (1) is set.
